(19) United States
(12) Patent Application Publication
(10) Pub. No.: US 2007/0298272 A1
(43) Pub. Date: Dec. 27, 2007

(54) Gasket, Method For Producing The Gasket, And Gasket Installation Method

(75) Inventors: Kouichi Kusakawa, Kanagawa (JP); Shigeki Ichimura, Kanagawa (JP); Taisuke Suwa, Kanagawa (JP)

Correspondence Address: KRATZ, QUINTOS & HANSON, LLP, 1420 K Street, N.W., Suite 400, WASHINGTON, DC, 20005, US

(73) Assignee: NHK SPRING CO., LTD., Yokohama-shi (JP)

(21) Appl. No.: 11/631,856

(22) PCT Filed: Jul. 8, 2005
(86) PCT No.: PCT/JP05/12697

§ 371 Date: Sep. 6, 2007

(30) Foreign Application Priority Data
Jul. 8, 2004 (JP) 2004-202147
Nov. 25, 2004 (JP) 2004-341099

(51) Int. Cl. F16J 15/00

(52) U.S. Cl. 428/515; 156/499; 264/160; 264/176.1

(57) ABSTRACT

Provided are a gasket that is less likely to deform and installable with excellent workability when it is installed at a portion to be sealed and that can be produced at low cost, a method of producing the gasket, and a gasket installation method. A previously prepared thermoplastic resin film with a predetermined shape is placed in a metal mold composed of a stationary side metal mold and a movable side metal mold. Then, thermoplastic elastomer as an elastic body is insert molded on the film by an injection molding machine to form a gasket. After the molding, the gasket is removed from the metal molds.

### TECHNICAL FIELD

The present invention relates to a gasket, a method for producing the same and a method for attaching the gasket. In particular, the present invention relates to gaskets including the gasket for sealing a gap between a cover and a main body of a hard disc drive (HDD) apparatus and the gasket for sealing a gap between separators of a fuel battery, the gaskets for the purpose of sealing for protecting various electronic items such as communication tools such as mobile phones, OA equipments and electronic circuit boxes mounted in automobiles, which are vulnerable to moisture, exhaust gas and dusts, and methods for producing the same and methods for attaching the gasket.

### BACKGROUND ART

With requests for downsizing electronic items with high performance, it has been hoped and desired to thin down component parts thereof. In order to respond to such requests, a casing body and a cover of the electronic item have been thinned down. As a result, rigidity of each component member tends to be reduced, and in response to the rigidity reduction, thin, fine and soft gaskets for sealing have been required.

The gasket for electronic items is originally fine as a rubber band. Thus if softer ones are required, their handling worsens. For example, when the gasket is installed on the cover of HDD, positioning becomes difficult and workability becomes very poor. Several remedial measures for this have been proposed as described below.

Patent document 1 discloses “a laminate composed of a central layer composed of a film or a sheet of a rigidity-imparting resin layer, a coherent layer integrated on one side of the central layer and composed of a film or a sheet of non-foam rubber or non-foam elastic plastic with low rigidity where hardness is smaller than the central layer, and an elastic layer integrated on the other side of the central layer and composed of rubber or elastic plastic foam whose hardness is smaller than in the coherent layer, and making a packing material by punching out the whole layers into a ring shape”.

In Patent document 1, the packing shape is easily kept and attaching work to a site to be sealed subjected to attachment becomes easy because the central layer having the rich rigidity has been provided. In addition, rubber materials on both sides of the central layer realize good sealing ability.

Patent document 2 discloses “a seal material of an electric equipment comprising a seal layer composed of a porous body such as a foamed synthetic resin or a sponge, an adhesive layer laminated on the seal layer, and a separator laminated on the adhesive layer, wherein the seal layer further has a reinforcing layer disposed between the seal layers, the reinforcing layer consisting of a sheet or a film of a synthetic resin which adheres to the seal layer and the adhesive layer”.

The seal material disclosed in Patent document 2 has the constitution of the seal layer (foam)/adhesive layer/reinforcing film layer/adhesive layer/separator, and the reinforcing film layer is used as an intermediate layer. In Patent document 2, the shape of the seal material is easily kept by the rigid intermediate layer, thereby making it easy to attach the seal material to the site to be sealed, i.e., the subject to which the seal material is attached.

Patent document 3 discloses “a method for producing a seal material, in which packings are formed on both sides of a film by supplying a resin in a fluid state from one side of the film having a hole and let the resin leak through the hole to the other side” and a “seal material” obtained thereby.

In Patent document 3, since the intermediate layer of the seal material is composed of the rigid film, the shape of the seal material is easily kept by the rigid intermediate layer, thereby making it easy to attach the seal material to the site to be sealed, i.e., the subject to which the seal material is attached.

Patent document 4 discloses a seal material having the constitution in which “a sheet is provided on one side of a gasket base substance formed of an elastic body, a gasket base substance side as an attached side is adhered to a site to be sealed, and subsequently the sheet is peeled”.

In Patent document 4, the gasket base substance is supported with the rigid film until being adhered to the site to be sealed. Thus it is made easy to attach the seal material to the site to be sealed, i.e., the subject to which the seal material is attached.

Patent document 5 discloses “a frame-integrate a gasket obtained by fusion-bonding a gasket obtained by injection molding of thermoplastic elastomer to the frame of polypropylene using metallocene catalyst”.

Patent document 6 discloses “a frame-integrated gasket obtained by fusion-bonding a gasket obtained by injection molding of thermoplastic elastomer to the frame of polypropylene having a crystallinity of 60 to 85%”.

Patent documents 5 and 6 relate to the gaskets having a frame, and disclose that the rigidity is given to the gasket by employing the frame, thereby improving a loading property for the site to be sealed, i.e., the subject to which the seal material is attached. According to production methods in these Patent documents 5 and 6, it is disclosed that the frame is integrated with the gasket by a bicolor molding method, or an insert molding method in which the frame having a predetermined shape is made, this frame is placed in a metal mold and subsequently the thermoplastic elastomer is injection-molded on the frame.

Patent Document 1: JP Hei-9-189362 A

Patent Document 2: JP Hei-10-173364 A

Patent Document 3: Patent No. 3022804 B

Patent Document 4: JP 2003-120816 A

Patent Document 5: JP 2000-240801 A

Patent Document 6: JP 2000-240802 A

### DISCLOSURE OF INVENTION

### Problem to be Solved by the Invention

In Patent document 1, an attachment property to the site to be sealed is improved to some extent, but the further improvement is desired. In particular, it is desired to simultaneously realize the improvement of the attachment property, reduction of the material used and simplification of the production process. A loss arises to increase wastes because the gasket is obtained by punching out a laminated product. The loss can not be recycled, and thus just has to be burned up. A complicated production process is required for producing a laminated structure, leading to a shortcoming of high cost.

In Patent document 2, it is a problem to reduce the materials used because the final product is a punched product. The sheet material to which the seal layer of the foam synthetic resin has been adhered is punched out through the reinforced layer composed of the sheet or the film of the synthetic resin. Thus, the loss produced by punching out just has to be burned out or landfilled because different materials are mixed in the punching loss. A publicly known double stick tape is used for the adhesion of the seal layer and the reinforcing layer 14, and an additional step is required for adhering them.

In Patent document 3, a seal part of the other side is formed by letting the resin leak from one side to the other side of the film through the hole in the film. Therefore, even when the resin used has a low viscosity, a void is easily left in the vicinity of the hole, and if the void occurs, a sealing property at that portion is inevitably deteriorated. In this constitution, it is impossible to perform injection-molding using the thermoplastic resin.

In Patent document 4, a mold releasing treatment is required for the film so that the support film can be peeled off from the gasket base substance. When a silicone material usually used is used for this mold releasing treatment, if HDD is subjected to the attachment, a hard disc property may be deteriorated due to decomposition of a silicone component on the hard disc surface. Thus, in this Patent document 4, the film to which the mold releasing treatment using the silicone material is not necessary to be given, i.e., the special film itself having high mold releasing property is used as the support film. In Patent document 4, a laminated sheet composed of the support film and the gasket base substance is made and subsequently punched out into the predetermined shape. Thus, the punching loss arises.

As a sectional shape of the gasket, a dome shape can not be made, and only a quadrangle can be made. Therefore, it is impossible to reduce the hardness of the gasket by controlling the sectional shape to reduce a compression area. Thus, the reduction of hardness of the gasket must be accomplished by reducing the hardness of the material itself, and it is highly difficult to reduce the hardness. This way, in the gasket disclosed in Patent document 4, the attachment property to the site to be sealed is improved to some extent, but it is pointed out as the problem that the reduction of the materials used and the simplification of the production process are realized as such a performance is kept.

The gasket with the frame in Patent document 5 requires a groove so that an applied position of the gasket is not misaligned in housing of the HDD main body when attached in HDD, and requires the structure in which the gasket is folded in the groove. Thus, an additional processing is required for the housing, leading to high cost up. The frame is made, and integrated with gasket by the insert molding or the bicolor molding. Thus, another step and another metal mold are required for making the frame. Therefore, there is the shortcoming in that a molding cycle becomes long leading to the cost up.

The gasket with the frame in Patent document 6 is different from the gasket with frame in Patent document 5 only in composition of polypropylene which becomes the frame, and has the same shortcoming as in Patent document 5 in that the frame is integrated.

As in the above, Patent documents 1, 2 and 4 are the punching products, Patent document 3 is a product formed by molding, and Patent documents 5 and 6 are the products with the frame. These gaskets in the conventional art are individually discrete products, each gasket must be produced individually, and it is difficult to automate their transport and assembly. Thus, a product form easily automated has been desired.

The present invention was made in the light of the aforementioned circumstance, and its object is to provide the gasket having the following characteristics and the method for producing the same and the method for attaching the gasket. That is:
(1) To provide an extremely soft gasket capable of being produced by injection molding with good productivity.
(2) To provide a gasket which is hardly deformed and has a good attachment workability when attached at a site to be sealed.
(3) To realize a film-integrated gasket using an inexpensive film used commonly without using a special film as a support film is provided, and the reduction of production cost.
(4) To provide a gasket having a good takeoff property after the injection molding even when the gasket is composed of a soft foam.
(5) To provide a simple and rational method for attachment as a method for attaching a gasket at the site to be sealed.
(6) To provide a gasket using inexpensive materials used very commonly, reducing a loss as possible and realizing low cost.
(7) To provide a gasket capable of being automatically produced, transported and built.

### Means for Solving Problem

In order to solve the aforementioned problems, the gasket of the present invention comprises a resin film and an elastic body molded on the resin film by injection molding and composed of a thermoplastic elastomer.

In the gasket of the present invention, the elastic body may be fixed peelably onto one side of the resin film. Alternatively, the elastic body may be fusion-bonded on one side of the resin film. It should be noted that the present gasket includes both of them.

The elastic body may preferably be integrated and molded on one side of the resin film by insert molding.

The “insert molding” as used herein means a molding method in which a resin is molded on one side of a previously prepared film.

In the gasket in which the elastic body is fusion-bonded on one side of the resin film, it is desirable that the resin film is cut along a shape of the elastic body or an external shape of the elastic body.

In the gasket of the present invention, it is preferable that the resin film consists of an olefin-based resin film, and the elastic body consists of an olefin-based elastomer or a styrene-based elastomer.

In the method for producing the gasket in which the elastic body is peelably fixed onto one side of the resin film, the elastic body is fixed onto one side of the resin film to which a surface mold releasing treatment has not been given, by injection molding under a condition where the film is not fusion-bonded to the elastic body, to obtain a gasket.

The condition where the film is not fusion-bonded is realized by, e.g., setting a surface temperature of the resin film to a temperature equal to or less than a melting point of the resin film. That is, the film's temperature rising upon molding the gasket on the resin film may be suppressed by the metal mold which contacts the film, which enables attenuated adhesion to the extent that the gasket is not totally fusion-bonded with the resin film and an extremely small portion thereof is slightly fixed. As a result, the elastic body can be peeled off from the resin film with a very slight tensile strength. Although peeling becomes easy, the gasket will not be peeled off unless any particular peeling force is applied until the gasket is located on the site to be sealed and fixed.

On the contrary, in the method for producing the gasket in which the elastic body is fusion-bonded on one side of the resin film, the elastic body is fusion-bonded onto one side of the resin film to which a surface mold releasing treatment has not been given, by injection molding under a condition where the film is fusion-bonded to the elastic body, and then the resin film to which the elastic body has been fusion-bonded is then cut off along a shape of the elastic body or an external shape of the elastic body, to obtain the gasket.

As the resin film, sheet-shaped resin films may be used. In place of the sheet-shaped films, a roll-shaped resin film may also be used.

Continuous production of the gasket in which the elastic body is peelably fixed on one side of the resin film may also be performed by continuously supplying a roll-shaped or sheet-shaped resin film to a metal mold for injection molding, peelably fixing an elastic body onto one side of the resin film by continuously forming the elastic body on the resin film by injection molding under a condition where the resin film is not fusion-bonded to the elastic body composed of a thermoplastic elastomer, and cutting the resin film on which the elastic body has been fixed without winding up the film, to obtain a sheet-shaped products.

Continuous production of the gasket in which the elastic body is fusion-bonded on one side of the resin film may be performed by continuously supplying a roll-shaped or sheet-shaped resin film to a metal mold for injection molding, fusion-bonding an elastic body onto one side of the resin film by continuously forming the elastic body on the resin film by injection molding under a condition where the resin film is fusion-bonded to the elastic body composed of a thermoplastic-elastomer; and cutting the resin film on which the elastic body has been fusion-bonded, the cutting being performed along a shape of the elastic body or an external shape of the elastic body, to obtain the gasket.

Subsequently, the method for attaching the gasket in which the elastic body is peelably fixed on one side of the resin film comprises peelably fixing an elastic body onto one side of a resin film wherein the elastic body has been molded by injection molding and composed of a thermoplastic elastomer, fixing onto a site to be sealed an uncovered side of the elastic body which has been fixed to the resin film, and peeling the resin film off from the elastic body fixed to the site to be sealed.

It is important that the fixation of the elastic body to the site to be sealed is performed more strongly than fixation of the elastic body to the resin film.

The fixation of the elastic body to the site to be sealed may be effected using an adhesive. As the adhesive, an olefin-based adhesive and an olefin-based urethane-reactive type adhesive may be used.

Alternatively, the fixation of the elastic body to the site to be sealed may be effected by fusion-bonding with heat.

The method for attaching a gasket of the present invention comprises peelably fixing an elastic body onto one side of a resin film wherein the elastic body has been molded by injection molding and composed of a thermoplastic elastomer, retaining the elastic body by a fixing jig with keeping its shape, subsequently peeling the resin film off from the elastic body, fixing an uncovered peeled side of the elastic body onto a site to be sealed, and removing the fixing jig from the elastic body fixed to the site to be sealed.

It is important that the force of the fixing jig for retaining the elastic body is set more strongly than force for fixing the gasket to the resin film, and fixation of the elastic body to the site to be sealed is set more strongly than force of the fixing jig for retaining the gasket.

The fixation of the elastic body to the site to be sealed may be effected using an adhesive, or by fusion-bonding with heat.

The method for attaching a gasket comprises providing a gasket composed of of a resin film and an elastic body being fusion-bonded onto one side of the resin film wherein the elastic body is molded by injection molding and composed of a thermoplastic elastomer and wherein the resin film is cut along a shape of the elastic body or an external shape of the elastic body, applying an adhesive onto at least all peripheral portion along an elastic body on a resin film surface of the gasket, and sticking the gasket onto a site to be sealed.

Similarly to the aforementioned method, the fixation of the resin film to the site to be sealed may be effected using an adhesive. As the adhesive, an olefin-based adhesive and an olefin-based urethane-reactive type adhesive which are similar to those mentioned above may be used.

Another attaching method comprises continuously supplying a roll-shaped film or sheet-shaped resin films to a metal mold for injection molding, fusion-bonding an elastic body onto one side of the resin film by continuously forming the elastic body on the resin film by injection molding under a condition where the resin film is fusion-bonded to the elastic body composed of a thermoplastic elastomer, cutting the resin film on which the elastic body has been fusion-bonded wherein the cutting is performed along a shape of the elastic body or an external shape of the elastic body, applying an adhesive onto at least all peripheral portion along the elastic body on the resin film side, and sticking the resin film onto a site to be sealed.

The fixation of the resin film onto the site to be sealed may also be performed by fusion-bonding with heat. That is, the method for attaching a gasket comprises providing a gasket comprising a resin film and an elastic body being fusion-bonded onto one side of the resin film wherein the elastic body is molded by injection molding and composed of a thermoplastic elastomer and wherein the resin film is cut along a shape of the elastic body or an external shape of the elastic body, placing the resin film in contact with a site to be sealed, and heating the resin film to stick the resin film onto the site to be sealed.

Another method for attaching a gasket of the present invention comprises continuously supplying a roll-shaped film or sheet-shaped resin films to a metal mold for injection molding, fusion-bonding an elastic body onto one side of the resin film by continuously forming the elastic body on the resin film by injection molding under a condition where the resin film is fusion-bonded to the elastic body composed of a thermoplastic elastomer, cutting the resin film on which the elastic body has been fusion-bonded, the cutting being performed along a shape of the elastic body or an external shape of the elastic body, placing the resin film in contact with a site to be sealed, and heating the resin film to stick the resin film onto the site to be sealed.

### EFFECT OF THE INVENTION

According to the present invention, the following effects can be obtained. First, by comprising the film, handling easiness of the gasket of the present invention is enhanced as well as the gasket of the invention can be stored as a wound roll or cut into a predetermined size. The effects to easily automate the transport and build are also obtained.

Subsequently, in the gasket in which the elastic body is fixed peelably onto one side of the resin film, the following effects are obtained.
(i) A film-integrated gasket can be produced by injection molding, a framework removal property from the mold is also good, and the productivity is good.
(ii) Because of being the film-integrated gasket, the gasket is not deformed upon attachment, the workability is good and the attachment cost is reduced.
(iii) The resin film-integrated gasket is directly positioned at the site to be sealed, fixed at the site to be sealed, subsequently, the resin film is peeled and removed, or the gasket is retained through a fixing jig, an uncovered side of the gasket is positioned at the site to be sealed in a state where the support film has been peeled and fixed at the site to be sealed, and subsequently the fixing jig is removed. Thus, only the elastic body is attached to the site to be sealed, and the elastic body is directly contacted with any sides opposed to the site to be sealed. Therefore, a sealing property of the site sealed with the gasket of the present invention is very good.
(iv) An inexpensive olefin film can be applied to the film used as the resin film supporting the gasket, thus is economical and can be reused. Additionally, when the film becomes unsuitable for the reuse and is burned up after disposition, no harmful gas is generated.
(v) Since the soft foam gasket can be integrated with the film, the productivity and the takeoff property are also good.
(vi) The gasket is made using the thermoplastic elastomer. Thus, the work by thermal fusion bonding is possible, and the use of an adhesive is not needed, the productivity is high, and clean sealing with no concern of generated gas, e.g., organic solvents becomes possible.
(vii) The film can be continuously supplied, the gasket can be continuously produced and further the transport and the assembly can be automated, which are extremely efficient.

Subsequently, in the gasket in which the elastic body is fusion-bonded on one side of the resin film, the following effects are obtained.
(i) In the gasket in which the elastic body is fusion-bonded on one side of the resin film, the gasket is not deformed upon attachment and the workability is also good. Thus, the attachment cost can be reduced.
(ii) The resin film-integrated gasket can be produced by injection molding, the gasket where a framework removal property from the mold is also good and the productivity is good can be provided.
(iii) The film can be continuously supplied, the gasket can be continuously produced, and unmanned operation of the line can be realized, which are extremely efficient.

According to the present invention, the resin film side of the gasket comprising the integrated resin film is adhered to the site to be sealed, and thus, the extremely good sealing property can be realized.

(iv) An inexpensive resin film such as olefin film can be used for the resin film and is economical. In addition, since the resin film and elastic body gasket are the same resin, they may be used by melting again. Furthermore, even when they are burned up after the disposition, no harmful gas is generated.

(v) By utilizing the resin film being the thermoplastic resin, the attachment by thermal fusion bonding is possible, and the use of an adhesive is not needed, the productivity is high, and clean sealing with no concern of gas generation from organic solvents becomes possible.

(vi) The film can be continuously supplied, the gasket can be continuously produced and the transport and the assembly can be automated, which are extremely efficient.

### BRIEF DESCRIPTION OF DRAWINGS

FIG. 1 is a conceptual diagram illustrating an injection molding method of a gasket of the present invention.

FIG. 2 is a conceptual diagram illustrating the method for continuously producing the gasket of the present invention.

FIG. 3 is a perspective view of the continuous gasket obtained by the method for continuously producing the gasket of the present invention.

FIG. 4-1 is a view showing one embodiment of the method for producing the gasket of the present invention.

FIG. 4-2 is a view showing one embodiment of the method for producing the gasket of the present invention.

FIG. 5 is a view showing one embodiment of the method for producing the gasket of the present invention.

FIG. 6-1 is a view showing an appearance of a punching out of a resin film according to the production of the gasket of the present invention.

FIG. 6-2 is a view showing an appearance of the punching out of the resin film according to the production of the gasket of the present invention.

FIG. 6-3 is a view showing an appearance of the punching out of the resin film according to the production of the gasket of the present invention.

FIG. 6-4 is a view showing an appearance of the punching out of the resin film according to the production of the gasket of the present invention.

FIG. 7 is a view showing an appearance of installation of the gasket of the present invention to a cover of HDD.

FIG. 8 is a sectional configuration diagram of one example of a metal mold for molding the gasket, illustrating Example 1 of the present invention.

FIG. 9 is a schematic sectional view of the gasket to be used, illustrating Example 3 of the present invention.

FIG. 10 is a schematic sectional view of the gasket that is being attached to the cover of HDD, illustrating Example 3 of the present invention.

FIG. 11 is a schematic sectional view of the gasket that is attached to the cover of HDD, illustrating Example 3 of the present invention.

FIG. 12 is a schematic sectional view of the gasket temporarily fixed to a gasket fixing jig, illustrating Example 4 of the present invention.

FIG. 13 is a schematic sectional view of a state where the gasket was temporarily fixed to the gasket fixing jig and subsequently an adhesive layer was formed on the gasket surface, illustrating Example 4 of the present invention.

FIG. 14 is a schematic sectional view of a state where the adhesive layer on the gasket surface was adhered to the cover of HDD while the gasket was kept fixed to the gasket fixing jig, illustrating Example 4 of the present invention.

FIG. 15 is a schematic sectional view of a state where the gasket fixing jig was removed for completing attachment of the gasket to the cover of HDD, illustrating Example 4 of the present invention.

FIG. 16 is a schematic sectional view of a state where the gasket was temporarily fixed to the gasket fixing jig, illustrating Example 5 of the present invention.

FIG. 17 is a schematic sectional view of a state where the gasket surface was fusion-bonded to a heating portion (seal site) of the cover of HDD while the gasket was kept fixed to the gasket fixing jig, and subsequently the gasket fixing jig was removed for completing attachment of the gasket to the cover of HDD, illustrating Example 5 of the present invention.

FIG. 18 is a sectional view of the metal mold in Example 6 in the method for producing the gasket of the present invention.

FIG. 19-1 is a view showing an appearance of the punching out of the resin film in Example 6 according to the method for producing the gasket of the present invention.

FIG. 19-2 is a view showing an appearance of the punching out of the resin film in Example 6 according to the method for producing the gasket of the present invention.

FIG. 19-3 is a view showing an appearance of the punching out of the resin film in Example 6 according to the method for producing the gasket of the present invention.

FIG. 19-4 is a view showing an appearance of the punching out of the resin film in Example 6 according to the method for producing the gasket of the present invention.

FIG. 20 is a view showing an appearance of installation of the gasket of the present invention to a cover of HDD in Example 6.

### EXPLANATIONS OF LETTERS OR NUMERALS

1 Meta mold at fixed side
2 Metal mold at movable side
3 (Support) resin film
4 Elastic body
5 Spacer
6 Cavity
7 Void
8 Cover of HDD
8a Seal site (heating portion)
10 Gasket fixing jig
11, 12 Cavity
13 Adhesive
20 Gasket
30 Wound roll of resin film
31 Wound roll of gasket
100 Injection molding machine
101 Continuous injection molding apparatus
102 Film cut apparatus

### BEST MODES FOR CARRYING OUT THE INVENTION

The gasket and the method for producing the same and the method for attaching the gasket of the present invention will be described below in more detail.

Unless otherwise particularly described, the following description can be applied to both a gasket in which the elastic body is fixed peelably onto one side of the resin film and a gasket in which the elastic body is fusion-bonded onto one side of the resin film.

(Injection Molding of Elastic Body)

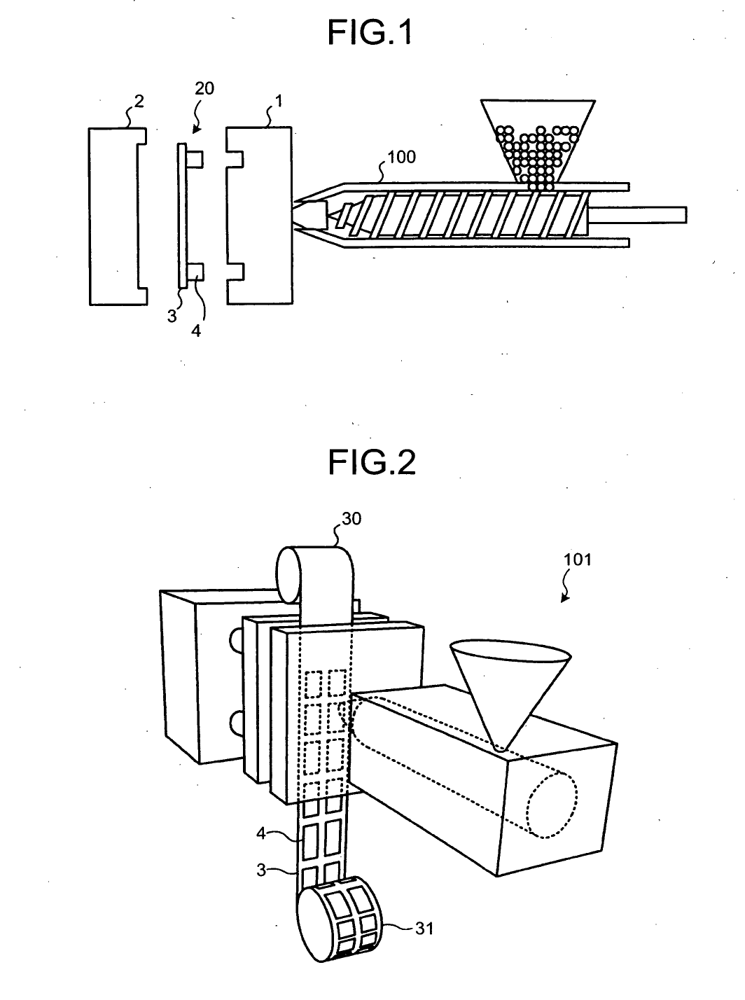

FIG. 1 is the conceptual diagram illustrating the injection molding method for producing the gasket of the present invention.

In FIG. 1, the gasket 20 according to the present invention has a resin film 3 and an elastic body 4 formed by injection molding and composed of a thermoplastic elastomer.

First, the case of producing the gasket 20 in which the elastic body 4 is fixed peelably onto one side of the resin film 3 will be described.

As shown in FIG. 1, the thermoplastic resin film 3 in a predetermined shape previously prepared is placed in the metal mold consisting of a fixed-side metal mold 1 and a movable-side metal mold 2. Then, an elastic body 4 is formed with a thermoplastic elastomer which is a raw material of the gasket on this film 3 by insert molding using an injection molding machine 100. After molding, the film-integrated gasket is removed from the metal mold 1 and the metal mold 2.

The gasket and the film are weakly fixed and become easily peelable by setting the temperature of the metal mold contacted with the film 3 at relatively low temperature so that the film 3 is not melted by the melted resin. When polypropylene is used as the film, it is preferable that the temperature of the mold is about 10 to 60° C. and a cylinder temperature for the thermoplastic elastomer is 180 to 230° C.

Subsequently, the case of producing the gasket 20 in which the elastic body 4 is fusion-bonded onto one side of the resin film 3 will be described.

First, the thermoplastic resin film 3 previously prepared is placed in the metal mold consisting of the fixed-side metal mold 1 and the movable-side metal mold 2. Subsequently, the thermoplastic elastomer which is the raw material of the elastic body 4 is fusion-bonded and insert-molded onto one side of this resin film 3 using the injection molding machine 100. After molding, the resin-film integrated gasket in which the elastic body 4 has been fusion-bonded onto the resin film 3 is removed from the metal mold 1 and the metal mold 2. Here, the inject-molded elastic body is sometimes referred to as the gasket.

The elastic body 4 and the film are fusion-bonded by setting the temperature of the metal mold contacted with the film 3 at relatively high temperature so that the resin film 3 is melted by the melted thermoplastic elastomer. When polypropylene is used as the film 3, the temperature of the mold is desirably about 40° C. or above, and the cylinder temperature for the thermoplastic elastomer is preferably 180 to 230° C. The temperature of the mold upon injection molding varies depending on a thermal capacity and the shape of the elastic body 4 and the combination of the raw materials for the film 3 and the elastic body 4.

In the cases of producing the gasket in which the elastic body is fixed peelably onto one side of the resin film and the gasket in which the elastic body is fusion-bonded onto one side of the resin film, a plurality of the elastic bodies may be formed at a time. That is, two to four elastic bodies 4 may be formed on the film 3 placed in the metal mold.

When the gasket 20 is molded by injection molding, it is preferable to equip means for air discharge such as gas vent in order to avoid occurrence of a weld line.

A foamed elastic body (foam body) can be produced by adding a foaming agent to the thermoplastic elastomer which is the raw material of the elastic body 4. For example, a thermally decomposed type foaming agent which is thermally decomposed to generate a gas can be combined with the thermoplastic elastomer. To perform molding of the foam body by injection molding, it is necessary to select the composition and the foaming agent suitable for the foaming depending on the thickness of the product. Generally, when the thickness is thinned to about 1 mm, it is preferable to use a nitrogen-based foaming agent, whereas when the thickness is thicker than this, a carbon dioxide-based foaming agent can be applied.

The foam body having a thick skin can be produced by injection molding with a slow injection speed and a low metal mold temperature. When a skin layer is thicker, a sealing performance of the gasket itself becomes higher. For facilitating further formation of the foam, it is preferable to reduce a mold clamping pressure after injecting the resin into the metal mold or expand clearance in the metal mold cavity after or during the injection. Specific examples of the foaming agent will be described later.

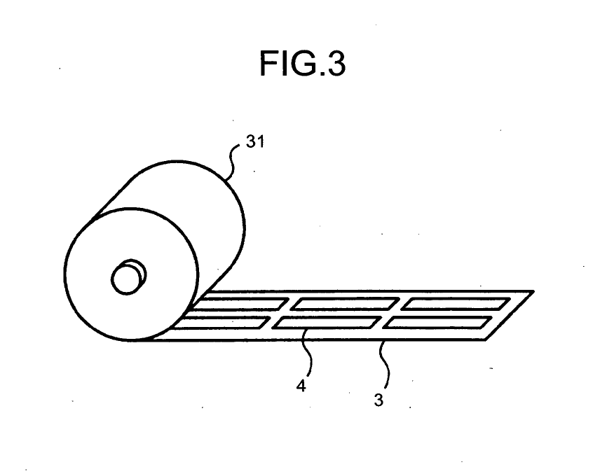

The injection molding to the film 3 can be continuously performed as shown in FIG. 2 onto a roll-wound film 30, i.e., the elastic body 4 can be continuously formed on the continuous film 6 using a continuous injection molding apparatus 101 capable of continuously performing injection molding. According to this continuous molding method, the gaskets can be produced in a large amount. The gaskets composed of the film 3 and the elastic body 4 can be stored as a wound roll 31 as shown in FIG. 3.

As this wound roll 31 is then wound backward, the gasket can be continuously positioned to the site to be sealed of, e.g. the cover of HDD, and attached. With the wound roll 31 obtained by continuously forming the elastic body 4 on the continuous film 3, the gaskets can be continuously produced at high speed in a large amount, and is very convenient for the transport and the storage.

After continuously injection molding on the roll-wound film, without rewinding the continuous film, the continuous film may be cut into a predetermined size suitable for the subsequent attachment step. In that case, winding winkles in the product can be prevented.

Furthermore, by previously cutting the roll-wound resin film 30 into the predetermined size, continuously supplying each film to the continuous injection molding machine 101 and molding the elastic body 4 on each film by insert molding, it becomes possible to continuously produce sheet-shaped gasket-integrated resin films.

By the gasket continuous molding method using these roll-shaped resin film 30 or sheet-shaped film, it becomes possible to produce the gaskets with extremely high productivity.

FIGS. 4-1 and 4-2 show a side view and a top plan view of an injection section, the metal mold 1 and the metal mold 2 in the continuous injection molding apparatus 101 of the gasket continuous molding system. The metal mold 1 and the metal mold 2 are assembled via spacers 5 disposed at four corners. The thickness of this spacer 5 is nearly the same as the thickness of the film 3. In the method for producing the gasket according to the present embodiments shown in FIGS. 2, 4-1 and 4-2, four elastic bodies 4 are formed at a time per one injection molding onto the film 3. The number of the elastic body formed per one molding can be appropriately changed by suitably changing the design of the metal molds 1 and 2.

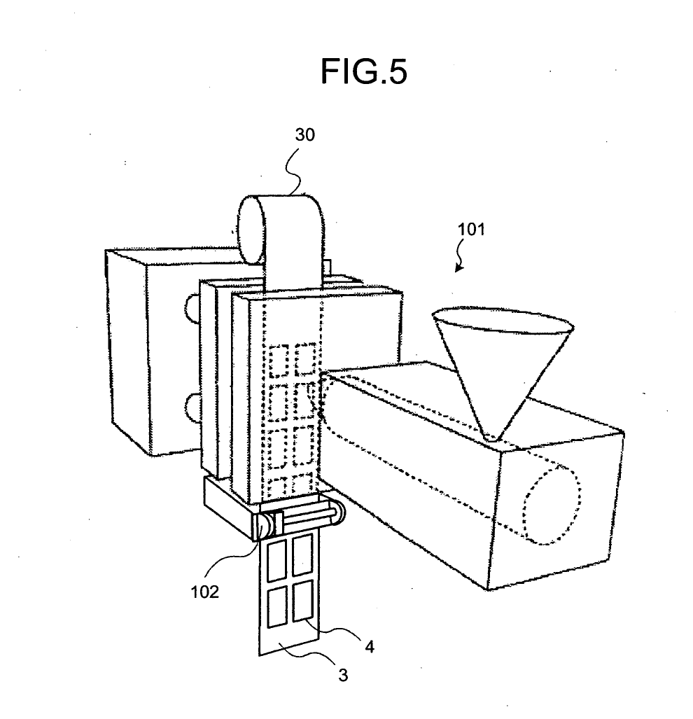

Now FIG. 5 is referred to. FIG. 5 shows an example of providing a film cutting apparatus 102 in the gasket continuous molding system shown in FIG. 2. After continuously forming the elastic body 4 on the roll-wound film 30, without rewinding the film 3, the film 3 may be cut into the predetermined size by the film cutting apparatus 102. In this case, the winding winkles can be prevented.

Subsequently, materials used for producing the gasket of the present invention will be described.

(Types of Resin Films)

The resin film used in the present invention is composed of a thermoplastic resin which may include polyolefin-based, polystyrene-based, polyester-based, polyamide-based, thermoplastic elastomer-based, polycarbonate-based and polyimide-based resins, and is selected on the basis of compatibility with the gasket raw material used.

First, in the case of the gasket in which the elastic body is fixed peelably onto one side of the resin film, the melting point of the film is preferably 150° C. or above in terms of avoiding deformation and fusion-bonding upon injection molding.

An adhesion force (i.e., peeling easiness) between the gasket and the resin film which supports the elastic body is necessary to be lower than the adhesion force between the site to be sealed and the gasket. This adhesion force (peeling easiness) is required to be a certain extent so that the gasket is not peeled off from the support film when the gasket is removed from the metal mold and when the gasket is positioned to the site to be sealed. This adhesion force (peeling easiness) can be controlled by properly selecting the type of the film, the compatibility with the thermoplastic elastomer and the injection condition.

For example, when the gasket raw material is olefin-based elastomer or styrene-based elastomer containing an olefin component, it is preferable to select the olefin-based film as the support film. If the polypropylene-based resin or the polymethylpentene-based resin is selected as a resin having the melting point of 150° C. or above for the elastic body raw material, the condition of the injection molding can be determined in the broad range, which enables controlling of the adhesion force to a proper value.

Meanwhile, in the case of the gasket in which the elastic body is fusion-bonded onto one side of the resin film, the melting point or a softening point of the film 3 is preferably 100° C. or above in order to prevent the deformation of the film upon injection molding.

The adhesion force between the film 3 and the elastic body 4 can be controlled by properly selecting the type of the film, the compatibility with the thermoplastic elastomer and the injection condition. For example, when the raw material of the elastic body is olefin-based elastomer or styrene-based elastomer, it is preferable to select the olefin-based film for the film 3. In particular, if the polypropylene-based resin, the polyethylene-based resin or the polymethylpentene-based resin is selected as the resin having the melting point of 100° C. or above, the condition of the injection molding can be determined in the broad range and the adhesion force can be properly controlled.

Subsequently, the thickness of the film will be explained.

First, in the case of the gasket in which the elastic body is fixed peelably onto one side of the resin film, a thick support film is preferable in terms of rigidity. The cost therefor may be also considered for adjusting the thickness. Preferable thickness is preferably about 100 to 400 μm.

To control the peeling property of the film, a film consisting of two or more layers may be used, and a treatment such as coating for controlling a peeling force may be given to the film surface, although these are not essential. If it is desired to control the peeling property so that the resin film tends to stick onto the gasket, a surface treatment such as corona discharge treatment or ultraviolet ray irradiation may be given to the resin film surface.

The removed film can be reused as it is, if it keeps smooth surface. If smoothness is reduced, the smoothness can be restored by thermal treatment and the restored film may then be reused.

Meanwhile, in the case of the gasket in which the elastic body is fusion-bonded onto one side of the resin film, the thickness of the resin film 3 may be appropriately selected considering its rigidity, workability and cost, and is most preferably about 50 to 200 μm.

In order to control the fusion bonding property and the rigidity of the resin film 3, the resin film 3 may be consist of two or more layers, or a treatment such as coating for controlling the peeling force may be given to the surface of the resin film 3, although these conditions are not essential. A surface treatment such as corona discharge treatment or ultraviolet ray irradiation may also be given to the surface of the resin film 3.

(Thermoplastic Elastomer)

Subsequently, the thermoplastic elastomer which is the raw material of the elastic body 4 will be described. Examples of the thermoplastic elastomer may include olefin-based elastomer, styrene-based elastomer (containing the olefin component), urethane-based elastomer, ester-based elastomer, polyamide-based elastomer and fluorine rubber-based elastomer. Among them, olefin-based elastomer and styrene-based elastomer are preferable because they have properties such as low permeability of water, acid resistance, alkali resistance and low permeability of liquids.

The olefin-based elastomer has a low moisture permeability, and a majority of the molecule is composed of olefin-based hydrocarbon. Examples thereof may include those obtained by kneading olefin-based copolymer rubber and crystalline olefin-based plastic and those obtained by synthetic reaction of olefin-based monomer.

As the olefin-based copolymer rubber, copolymers of ethylene and α-olefin (e.g., propylene) and those obtained by further copolymerizing therewith a non-conjugated diene component may be suitably used.

As the crystalline olefin-based plastic, polymers and/or copolymers of α-olefin such as propylene are used. In this case, the kneading reaction can also be performed in the presence of a crosslinking agent or a crosslinking aid agent.

The olefin-based thermoplastic elastomer is suitable as a gasket material because of its excellent low moisture permeability, recoverability and moldability upon injection molding.

The styrene-based thermoplastic elastomer is a resin obtained by kneading hydrogenated styrene-butadiene copolymer or styrene-isoprene copolymer with another resin such as an olefin-based resin. Examples of the styrene-butadiene copolymer and styrene-isoprene copolymer may include those which are commercially available as so-called SBS or SIS block copolymers. The olefin-based thermoplastic elastomer exhibits excellent recoverability at high temperature, and the styrene-based thermoplastic elastomer exhibits excellent recoverability at around room temperature. Thus they may be used in combination.

When the elastomer material used for the present invention is a material which generates a large amount of gas, the material may be subjected to a baking step in which the material is treated with heat at high temperature for removing the gas. This baking step can be performed at the stage of the raw material or at the stage after forming the gasket. The treatment may be performed in vacuo.

The foam body can be produced by adding to the thermoplastic elastomer a thermally decomposed type foaming agent which is thermally decomposed to generate the gas. Specific examples of such a foaming agent may include organic foaming agent such as azodicarbonamide (ADCA), diethylazocarboxylate, barium azocarboxylate, 4,4-oxybis(benzenesulfonyl hydrazide), 3,3-disulfonehydrazide phenylsulfonate, N,N′-dinitrosopentamethylene tetramine, p-toluenesulfonylhydrazide and trihydrazinotriazine, and inorganic foaming agents such as sodium hydrogen carbonate, ammonium hydrogen carbonate and ammonium carbonate.

In particular, as the organic foaming agents, azodicarbonamide (ADCA), N,N′-dinitrosopentamethylene tetramine and trihydrazinotriazine are preferable. As the inorganic foaming agents, sodium hydrogen carbonate is preferable. Also preferable are a mixture of sodium hydrogen carbonate with any of citric acid and monosodium citrate, and a mixture of sodium hydrogen carbonate, monosodium citrate and glycerine fatty acid ether. These foaming agents can be used alone or in combination of two or more, or in combination with a so-called decomposition aid agent.

In the present invention, the resin can be foamed by butanes and pentanes as volatile solvents and water, in place of foaming by the thermally decomposed type foaming agent. The gas itself can also be dispersed or impregnated in a foam resin substrate. In this case, the foaming agent may include carbon dioxide gas and nitrogen gas.

The carbon dioxide gas generated by the reaction of sodium hydrogen carbonate with an acid, or the carbon dioxide gas generated by the reaction of an isocyanate compound with water can also be utilized. Water in a hydrous salt of calcium sulfate and aluminium hydroxide at high temperature may also be utilized as the foaming agent.

When the carbon dioxide is used or when the foaming agent which reacts or decomposes to release the carbon dioxide gas is used, the skin tends to be thickened. When the nitrogen-based foaming agent is used, the skin less tends to be thickened. These foaming agents can be used depending on the thickness of the product, a required foaming magnification and the composition ratio.

In the case of the gasket in which the elastic body is fusion-bonded onto one side of the resin film, the gasket is cut out (punched out, processed) per resin film.

FIGS. 6-1 and 6-2 are now referred to. FIGS. 6-1 and 6-2 show cutting treatments on the resin film according to the production of the gasket of the present invention. In the present embodiment, the resin film 3 is cut out (punched out, processed) along the shape of the elastic body 4. Cutting out the resin film 3 “along the shape of the elastic body 4” includes not only the case of cutting the resin film without the least difference from the shape of the elastic body 4 but also the case of cutting the resin film with adding a certain margin to the shape of the elastic body 4. The cutting of the resin film 3 includes punching out by a metal mold, cutting by a knife or scissors, cutting by water jet and other methods for cutting the resin film.

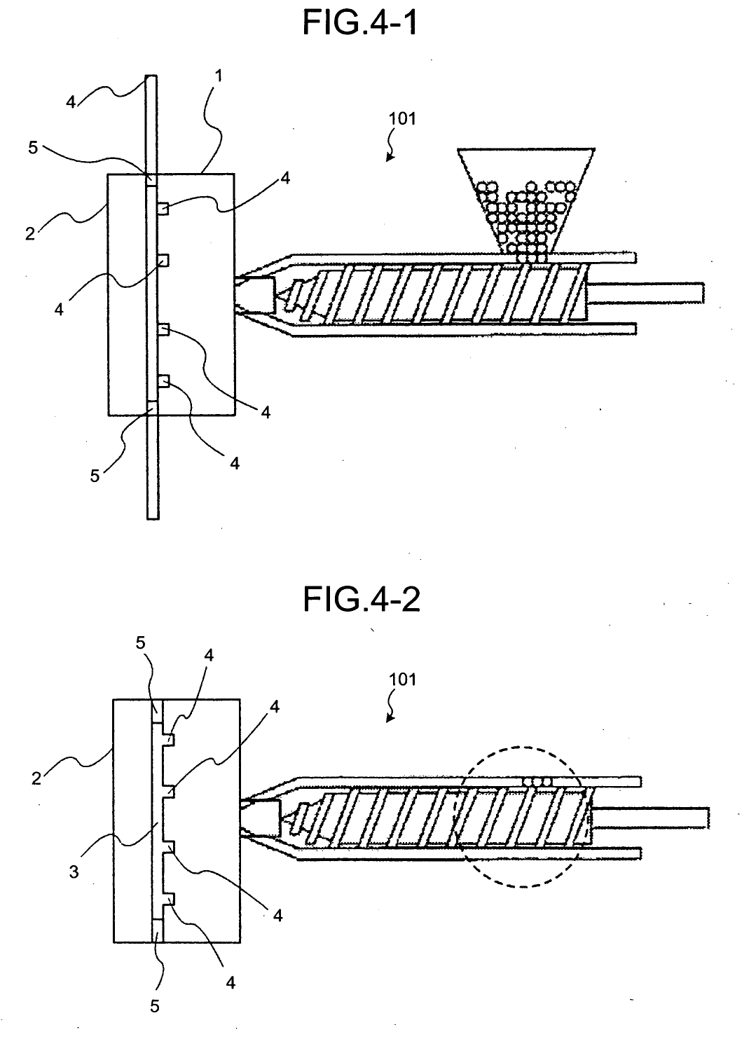

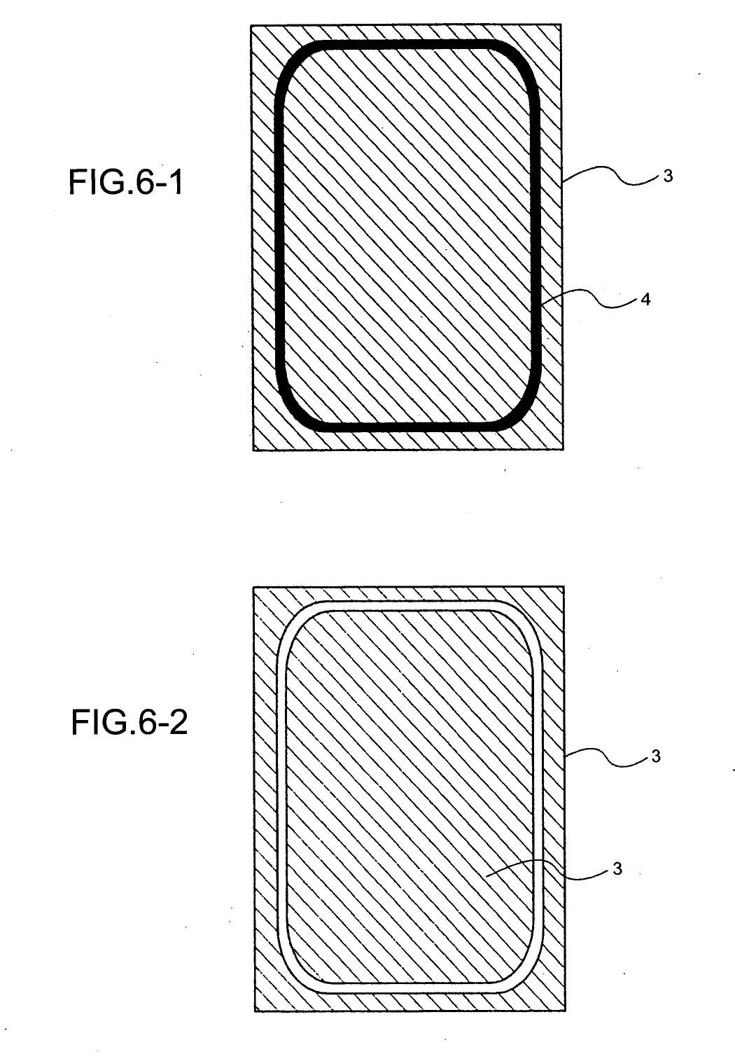

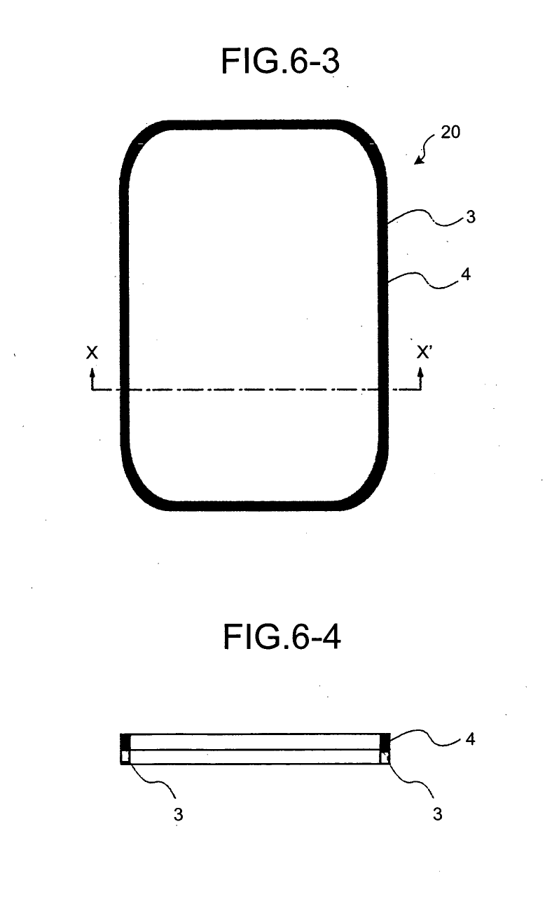

FIG. 6-1 shows the state in which the elastic body 4 has been formed on the resin film 4. Here, the resin film 3 is cut (punched out, processed) along the shape of the elastic body 4, the unnecessary resin film 3 is cut out as shown in FIG. 6-2, and the production of the gasket 20 in which the film 3 and the elastic body 4 have been integrated is completed as shown in FIG. 6-3. FIG. 6-4 is a sectional view showing a cross section along the x-x′ line in FIG. 6-3.

(Attachment of Gasket to Site to be Sealed)

Subsequently, the method for attaching the gasket to the site to be sealed will be described.

First, the case of attaching the gasket, in which the elastic body has been fusion-bonded onto one side of the resin film, to the site to be sealed will be described.

As shown in FIG. 7, an adhesive is applied to at least all peripheral portion along the elastic body 4 on the resin film 3 side of the gasket 20 of the present invention. The gasket is then placed in contact with the site to be sealed (sealed portion) 8 and firmly fixed. This site to be sealed is, for example an inside face of HDD. Since the gasket of the present invention are in contact with the site to be sealed via the adhesive applied on a part of the resin film 3 at all of the peripheral portion along the elastic body 4, the gasket of the present invention exhibits an extremely good sealing property.

The type of the adhesive is selected depending on the type of the resin film 3. When the olefin-based film is used as the resin film 3, it is preferable to use the olefin-based adhesive. Preferable examples of such resins may include polypropylene, polyethylene or polyvinyl acetate that have been given modification with a polar group, such as acid modification with maleic acid anhydrate, epoxy modification or hydroxyl group modification. Among the olefin-based adhesives, it is also preferable to use olefin-based urethane adhesives obtained by polymerizing olefin-based polyol such as hydrogenated butadiene and hydrogenated isoprene-based polyol with isocyanate, and olefin-based urethane reactive adhesives obtained by adding terminal isocyanate to an oligomer of olefin-based polyol, which is curable with water. Cyanoacrylate-based reactive adhesives can also be used.

Among them, the reactive adhesive such as olefin-based urethane reactive adhesive is preferable as a nonsolvent type. The olefin-based film is essentially poor in adhesiveness. However, when the gasket of the present invention is used with a cover of HDD or a fuel battery, the gasket is fixed with screws after the adhesion and thus the high adhesion force is not required. It is preferable that the resin film is firmly adhered to the gasket and the adhesion force is moderate because the film is easily peeled off after the use.

It has been described that the adhesives described above can be applied in the case of attaching the gasket onto the site to be sealed in which the elastic body is fusion-bonded onto one side of the resin film. The adhesives can also be similarly applied in the case of attaching the gasket onto the site to be sealed in which the elastic body is fixed peelably onto one side of the resin film.

In place of using adhesive for the adhesion of the resin film 3 and the site to be sealed (sealed portion), it is also preferable to employ fusion bonding to the site to be sealed with heat. This is to bring about adhesion of the resin film 3 and the site to be sealed by utilizing the resin film 3 which is a thermoplastic resin. To adhere by the fusion bonding method, the site to be sealed may be heated, or the surface of the resin film 3 of the gasket of the present invention may be heated. According to this fusion bonding method, it is not necessary to daringly use the adhesive, the method is simple, and the clean gasket can be provided without concern of gas generation.

Subsequently, the process for attaching the gasket onto the site to be sealed in which the elastic body is fixed peelably onto one side of the resin film will be described.

To attach the resulting film-integrated gasket to the site to be sealed, the adhesive is applied to the other side of the film and stuck, and thereafter the film is peeled off. Alternatively, the gasket is temporarily retained on a fixing jig while keeping its shape, the support film is then peeled off, the adhesive is applied to the peeled side, then the gasket is fixed to the site to be sealed, and subsequently the fixing jig is removed.

It is also possible to use the fixing jig for attaching the gasket. In any of these methods, the adhesive is not necessary to be applied to the entire uncovered surface of the gasket. It is preferable to use the adhesive in as small amount as possible in the range of surely fixing the gasket to the sealed side. As the type of the adhesive, a hot melt type and a reactive hot melt type are preferable because they contain no solvent.

In place of using the adhesive, it is preferable to perform fusion bonding to the site to be sealed with heat, utilizing the gasket material being the thermoplastic elastomer. In the fusion bonding method, the site to be sealed may be heated or the gasket surface may be heated. This method is simple because no adhesive is needed. This method provides a clean gasket without concern of gas generation.

As described above, according to the gasket of the present invention in the present embodiment, the gasket is not deformed upon attachment and the working cost can be reduced owing to the good workability because the gasket has the integrated resin film. According to the gasket of the present invention in the present embodiment, the gasket having the integrated resin film can be produced by injection molding, and the gasket which is easily removed from the mold and whose productivity is good can be provided. According to the method for producing the gasket of the present invention in the present embodiment, the gasket can be continuously produced by continuously supplying the resin film, which enables an extremely efficient unmanned operation of the production line.

It is possible to make a hole on a certain location of the resin film corresponding to a bolt hole of the HDD cover. Utilizing the hole, it is possible to perform automation of the assembly. Making of the hole in the resin film and molding of the elastic body on the resin film can be simultaneously performed upon injection molding by providing the injection metal mold with blanking die. This remarkably rationalizes an assembling step, and increases uniformity of the assembled position of the gaskets. The position at which the hole is made is not limited to that for the bolts. The hole may also be used for a variety of purposes such as a filter hole. Such a hole making step may be performed at a cutting step of the resin film. It is obvious that the products to which the gasket can be applied are not only HDD but also include fuel batteries and mobile phones.

The gasket according to the present invention can be obtained by injection molding as a continuous roll-wound shape or a strip shape having a predetermined length. Subsequently, the gasket is carried to subsequent steps such as a washing step and a adhesion step. Since the elastic body is formed on the resin film and both are integrated, the transport of the roll-wound products and the transport of strip-shaped products may be easily performed with an aid of vacuum. Thus the transport of the gasket products is easily automated.

Furthermore, since the elastic body is formed on the resin film and both are integrated, the gasket is easily secured by holding the resin film with an aid of vacuum when the adhesive is applied in the adhesion step or when the gasket is thermally fusion-bonded. Thus, the positioning becomes precise and easy, and the subsequent automatic assembly of the HDD cover may be easily performed.

According to the method for attaching the gasket in which the elastic body is fusion-bonded onto one side of the resin film by the present invention, the resin film of the gasket comprising the integrated resin film by fusion bonding is adhered to the site to be sealed. Thus, the extremely good sealing property can be realized. In the present invention, the inexpensive resin film such as olefin-based film can be used as the resin film, and thus the gasket is economical. And the resin film and the elastic body gasket can be the same resin, and thus, they may be melted again for reuse, or even when they are burned out after the disposition, no harmful gas is generated. Furthermore, according to the method for attaching the gasket of the present invention, utilizing the resin film being the thermoplastic resin, it is possible to attach the resin film to the site to be sealed by fusion bonding with heat. Thus, the adhesive is not needed, the productivity is high and the clean gasket can be provided without concern of gas generation from the organic solvent.

In the aforementioned embodiments and Examples described later, examples in which the gasket is attached to the cover of HDD are described, but the gasket and the method for attaching the same of the present invention are not limited thereto, and can be use as packings for lamps, packings for lamps for automobiles, gaskets for displays of mobile phones, gaskets for liquid crystal displays of personal computers and mobile phones, gaskets for fuel batteries, and gaskets used for other sealing purposes. The gasket and the method for attaching the same of the present invention can also be used for dampers of air conditioners in automobiles.

Examples of the present invention will be described below in detail based on the drawings. The Examples described below are only preferable exemplifications describing the present invention, and do not limit the present invention.

Examples 1 to 5 describe the gaskets in which the elastic body is fixed peelably onto one side of the resin film, the methods for producing them and the methods for attaching them. Examples 6 to 9 describe the gasket in which the elastic body is fusion-bonded onto one side of the resin film, the methods for producing them and the methods for attaching them.

### EXAMPLES

### Example 1

Process for Producing Film-Integrated Gasket

FIG. 8 is a cross-sectional view of a metal mold for molding the gasket of the present invention. In the figure, the numerals 1 and 2 represent the metal mold at a fixed side and the metal mold at a movable side, respectively, and 11 and 12 represent cavities. The cavity 11 is a section for inserting the resin film, and cavity 12 is a section for gasket injection.

PP film (110 mm [longitudinal]×80 mm [transversal]×200 μm [thickness]) was inserted in the cavity 11, the metal mold 1 at the fixed side and the metal mold 2 at the movable side were clamped, and an olefin-based thermoplastic elastomer (MFR: ASTM 1238, 190° C., 2.16 kgf, 10 g/10 minutes) which was the elastic body as a material for molding the gasket was injected in the cavity 12 at a cylinder temperature of 200° C., to perform molding of the gasket (injection condition: injection speed 200 mm/s, metal mold temperature 30° C.).

When the molded product was removed from the metal mold, removal from the mold was easy and the molded gasket product (gasket) in which the elastic body and the film had been integrated was produced in a state where the molded gasket had been weakly adhered (easily peeled) to the PP film. A molded state of the resulting elastic body on the film was good. When the elastic body was manually peeled off from the support film, it was found out that the adhesion was easily peelable.

### Example 2

Process for Producing Gasket Made of Foam Body

As the metal mold for molding, the metal mold shown in FIG. 1 was used in the same way as in Example 1. PP film (110 mm [longitudinal]×80 mm [transversal]×200 μm [thickness]) was inserted in the cavity 11 of this metal mold, and the metal mold 1 at the fixed side and the metal mold 2 at the movable side were clamped. 4 parts by weight of an inorganic foaming agent was added to an olefin-based thermoplastic elastomer (MFR: ASTM 1238, 190° C., 2.16 kgf, 10 g/10 minutes) which is the elastic body. The mixture was kneaded to prepare a master batch as the material for molding the gasket. This was injected into the cavity 12 at a cylinder temperature of 200° C. and the elastic body was foamed, to configure the foamed gasket (injection condition: injection speed 200 mm/s, metal mold temperature 30° C.).

When the molded product was removed from the metal mold, removal from the mold was easy and the foamed gasket molded product (foamed gasket, foam magnification 1.5 times) in which the elastic body and the film had been integrated was produced in the state where the molded gasket had been weakly adhered (easily peelable) to the PP film. The molded state of the resulting foam gasket on the film was good. When the elastic body of the foam gasket was manually peeled from the support film, it was found out that the adhesion was easily peelable.

### Example 3

Attachment of Gasket by Film-Integrated Gasket (1)

Attachment of the gasket on a cover of HDD was performed. The film-integrated gaskets produced in Examples 1 and 2 were used.

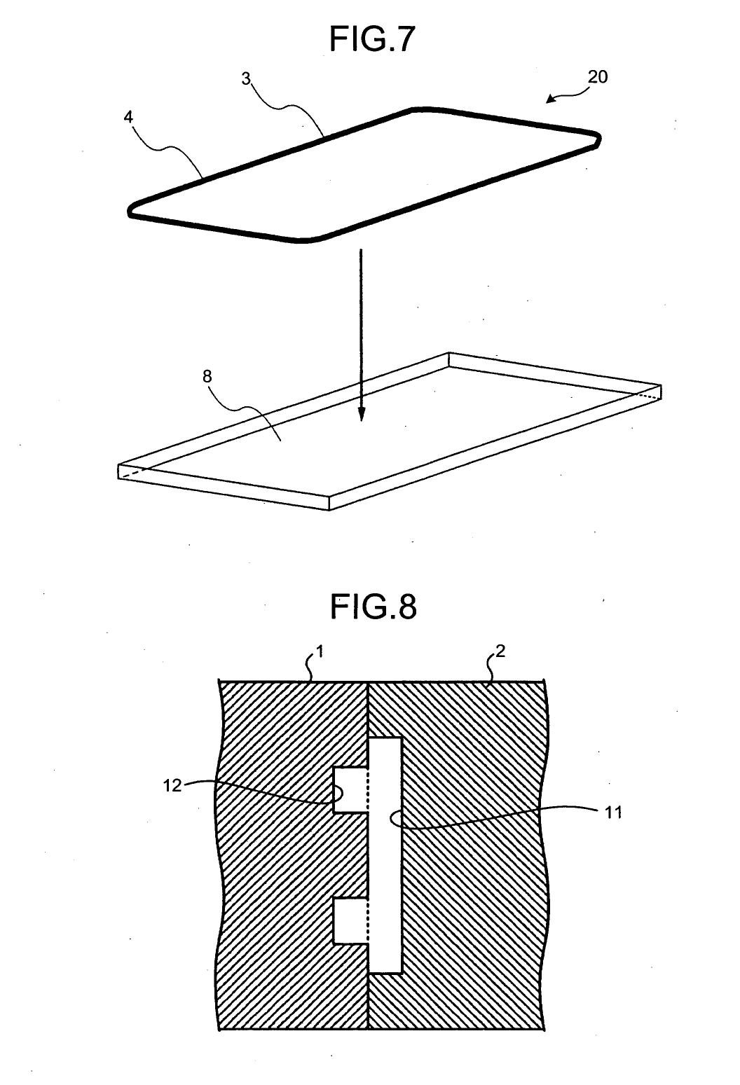

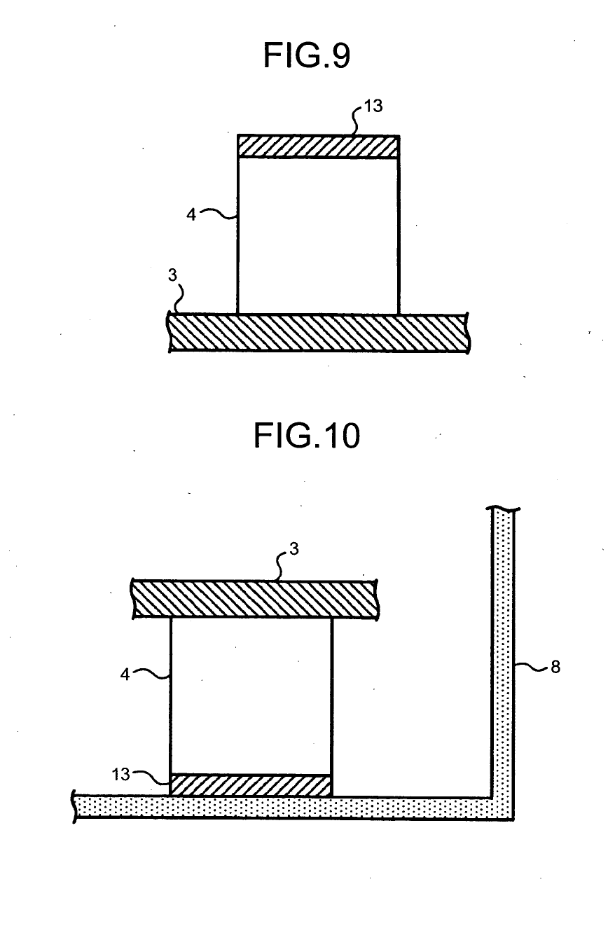

The method for attaching the gasket is described using FIGS. 9, 10 and 11. In these figures, the numerals 3, 4, 13 and 8 represent the support film, the elastic body, the adhesive and the cover of HDD, respectively.

As shown in FIG. 9, the olefin-based adhesive 13 is applied on an uncovered side of the elastic body 4 fixed to the support film 3 of the gasket. Subsequently, as shown in FIG. 10, the side on which the adhesive 13 had been applied was fixed by adhesion to an internal face of the cover 8 of HDD and the support film was peeled off to secure the elastic body 4 on the cover 8 of HDD as shown in FIG. 11.

In both cases of using the gaskets in Examples 1 and 2, the elastic body 4 was stably secured. The sealing property of this elastic body 4 was extremely good.

### Example 4

Attachment of Gasket by Film-Integrated Gasket (2)

Attachment of the gasket on a cover of HDD is performed in a similar manner to Example 3. The film-integrated gaskets produced in Examples 1 and 2 were used.

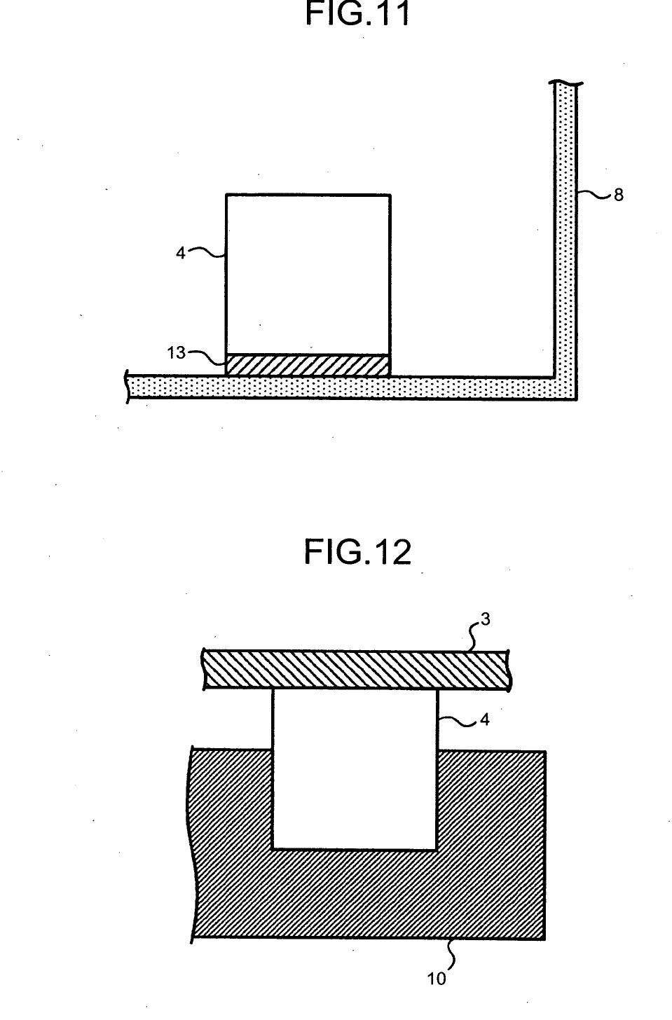

The method for attaching the gasket is described using FIGS. 12 to 15. In these figures, the numerals 3, 4, 13, 8 and 10 represent the support film, the elastic body, the adhesive, the cover of HDD and a fixing jig of the gasket, respectively.

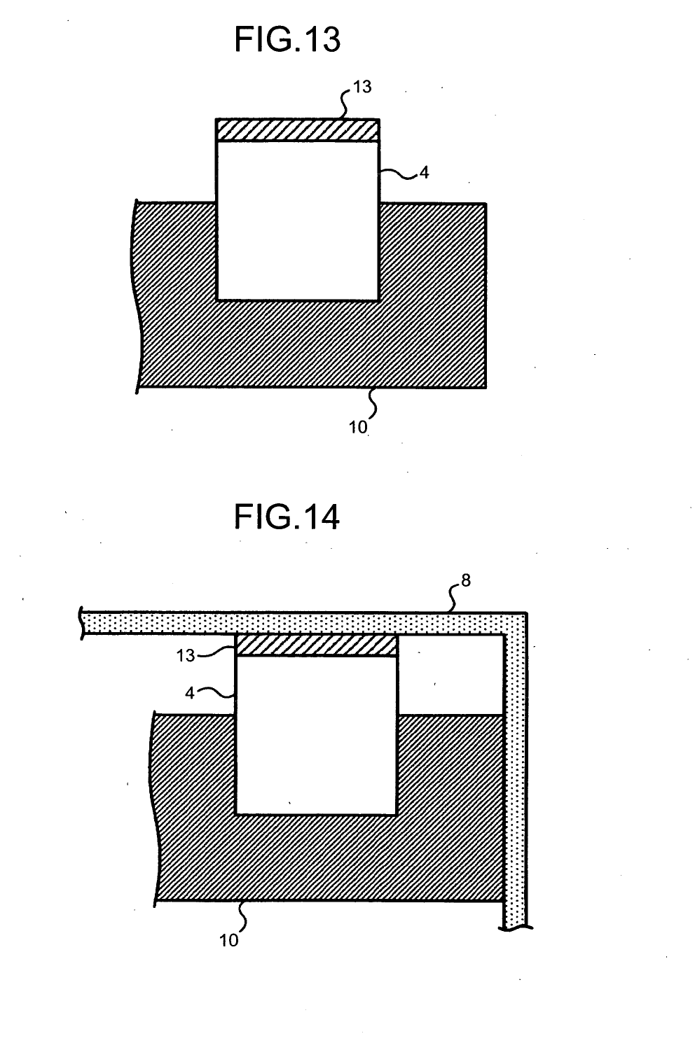

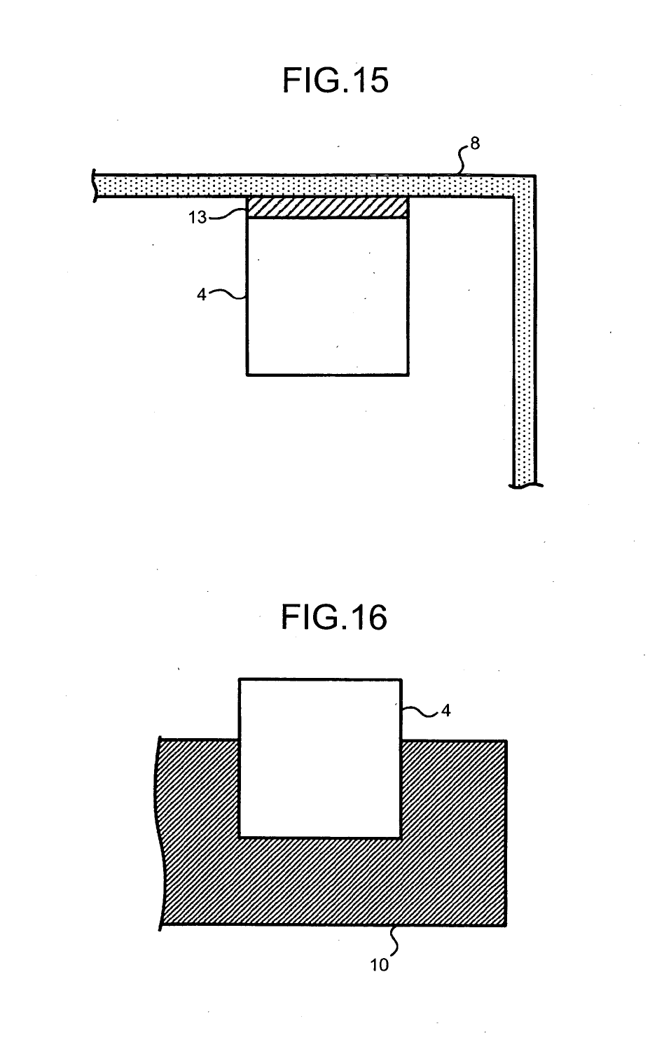

First, as shown in FIG. 12, the elastic body 4 of the film-integrated gasket produced in Examples 1 and 2 was set in the fixing jig 10. Subsequently, the support film 3 was peeled off, and as shown in FIG. 13, the olefin-based adhesive 13 was applied onto the peeled side of the gasket. As shown in FIG. 14, this side to which the adhesive 13 had been applied was pushed, adhered and fixed to the internal face of the cover of HDD. As shown in FIG. 15, when the fixing jig 10 was removed, the elastic body 4 was secured to the cover 8 of HDD.

In both cases of using the gaskets in Examples 1 and 2, the elastic body 4 was stably secured. The sealing property of this elastic body 4 was extremely good.

### Example 5

Attachment of Gasket by Fusion Bonding with Heat

Attachment of the gasket on a cover of HDD is performed in a similar manner to Examples 3 and 4. The film-integrated gaskets produced in Examples 1 and 2 were used.

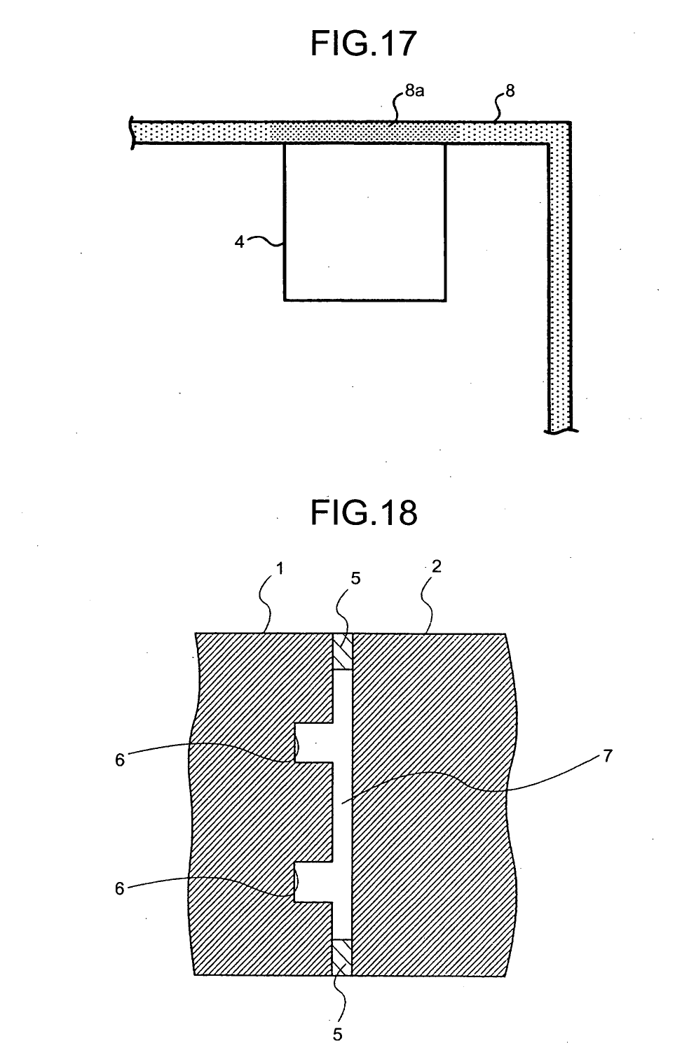

The method for attaching the gasket is described using FIGS. 16 and 17. In these figures, the numerals 3, 4, 13, 8 and 8a represent the support film, the elastic body, the adhesive, the cover of HDD, and the site to be heated when the site to be sealed of the cover 8 is heated, respectively.

First, as shown in FIG. 16, the elastic body 4 of the film-integrated gaskets produced in Examples 1 and 2 was set in the fixing jig 10, and the support film 3 was removed by peeling it off. Meanwhile, the site to be sealed on the cover 8 of HDD was heated by an electric heater, thereafter as shown in FIG. 17, the elastic body 4 fixed to the fixing jig 10 was placed in contact with the heated site (site to be sealed) in the cover 8 of HDD, and the elastic body 4 was fixed to the cover 8 by fusion-bonding with heat. This cover 8 was attached to an HDD main body which is not shown in the figure, and the sealing property of the HDD apparatus was examined. As a result, the sealing property was good.

### Example 6

In this Example, an example of producing the gasket of the present invention is described.

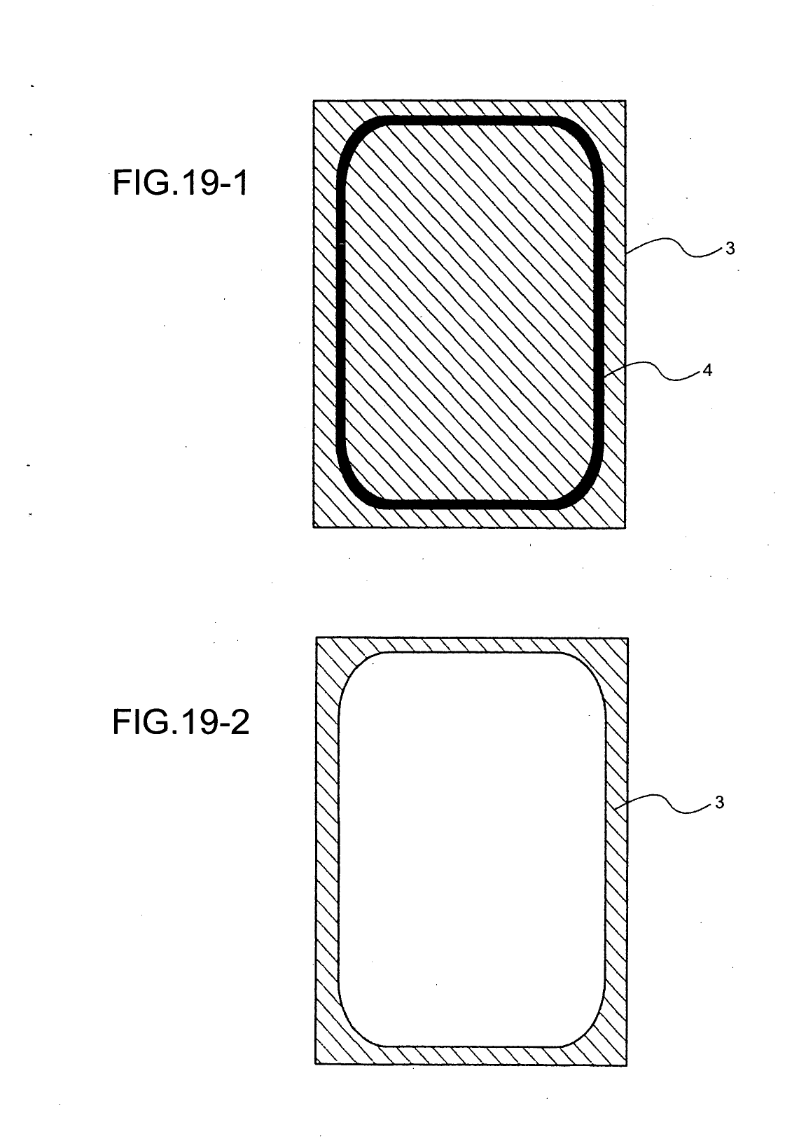

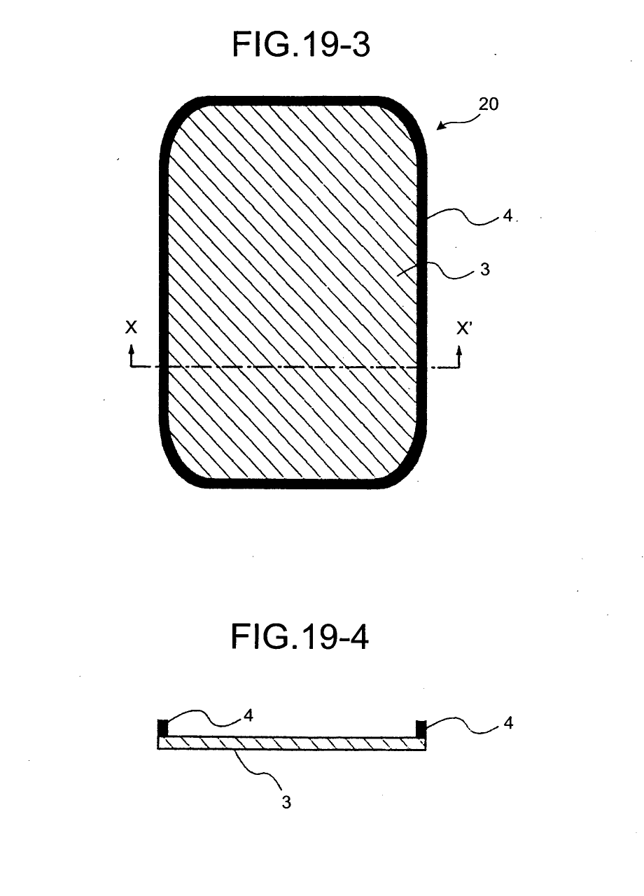

FIG. 18 is now referred to. The cross-sectional view of the metal mold used in the present Example is shown in FIG. 18. The metal molds 1 and 2 are assembled via four spacers 5 disposed at four corners. The thickness of this spacer 5 is nearly the same as the thickness of the film. The numerals 6 and 7 represent the cavity and a void, respectively. The void 7 plays a role of a slot for inserting the resin film. The cavity 6 is a section for injecting the elastic body 4.

Using the metal mold shown in FIG. 18 as the metal mold of the continuous injection molding system shown in FIG. 2, the elastic body 4 was injection-molded while the PP films were inserted with intervals. The molding was able to perform continuously performed with an extremely short time cycle. The resin for the elastic body 4 used in the present Example was olefin-based thermoplastic elastomer (MFR: ASTM 1238, 190° C., 2.16 kgf, 10 g/10 minutes), which was injection-molded into the clamped metal mold consisting of the metal mold at the fixed side and the metal mold at the movable side at a cylinder temperature of 200° C. (injection condition: injection speed 200 mm/s, metal mold temperature 40° C.).

When the molded product was removed from the metal mold, it was easily removed from the mold, and the molded gasket product having a good molded state was produced in which the thermoplastic elastomer and PP film was integrated in the fusion-bonded state. The molded gasket having the resin film can be directly wound up to be a roll shape, or can be cut into the predetermined length using the film cut apparatus shown in FIG. 5.

Subsequently, the gasket having the resin film on the elastic body is installed on the site to be sealed. In the installation, the gasket is cut (punched out) per resin film, the adhesive is applied onto the resin film side, and the gasket is stuck.

FIGS. 19-1 to 19-4 are now referred to. Cutting treatments of the resin film according to the formation of the gasket of the present invention are shown in FIGS. 19-1 to 19-4. In the present Example, the resin film 3 is cut along the external shape of the elastic body 4. Cutting out the resin film 3 “along the external shape of the elastic body 4” includes not only the case of cutting the resin film without the least difference from the external shape of the elastic body 4 but also the case of cutting the resin film with adding a certain margin to the external shape of the elastic body 4.

The cutting of the resin film 3 includes punching out by the metal mold, cutting by a knife or scissors, cutting by water jet and other methods for cutting the resin film. FIG. 19-1 shows the state in which the elastic body 4 has been formed on the resin film 4. Here, the resin film 3 is cut (punched out, processed) along the external shape of the elastic body 4, the unnecessary resin film 3 is cut out as shown in FIG. 19-2, and the production of the gasket in which the film 3 and the elastic body 4 have been integrated is completed as shown in FIG. 19-3. FIG. 19-4 is a sectional view showing a cross section along the x-x′ line in FIG. 19-3.

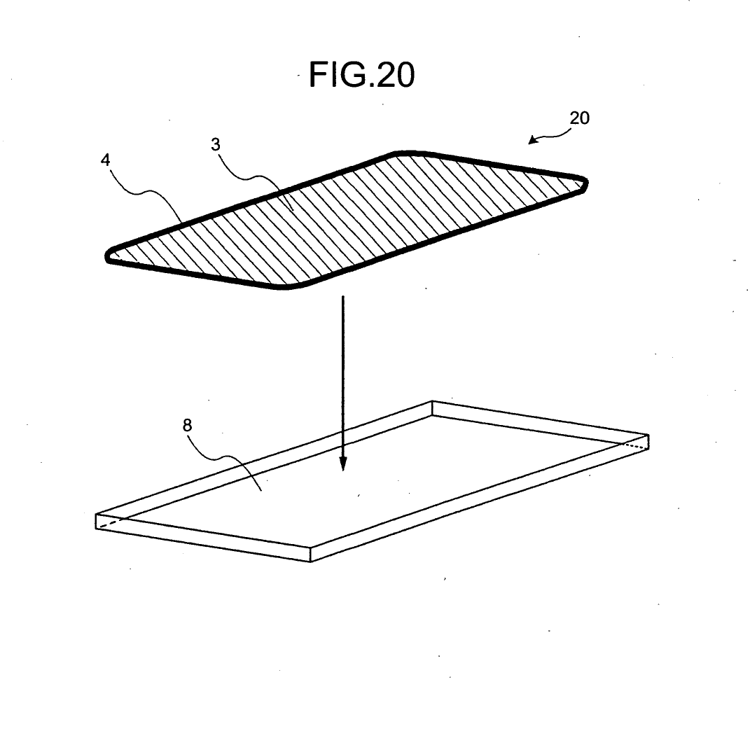

Subsequently, the gasket is fixed to the site to be sealed. FIG. 20 is now referred to. As shown in FIG. 20, an adhesive is applied to at least all peripheral portion along the elastic body 4 in the resin film 3 side of the gasket of the present invention. The gasket is then placed in contact with the site to be sealed (sealed portion) 8 and firmly fixed. In the present Example, the site to be sealed is the inside face of HDD. Since the gasket of the present invention are in contact with the site to be sealed via the adhesive applied on a part of the resin film 3 at least at all of the peripheral portion along the elastic body 4, the gasket of the present invention exhibited an extremely good sealing property.

In the present Example, the resin film 3 was cut along the external shape of the elastic body, and the gasket in which the film 3 and the elastic body had been integrated was used. This enables reduction of the loss of the resin film. This also enables reduction of noise leaking from HDD inside to the outside, i.e., a sound insulation effect was obtained.

### Example 7

In the present Example, the process for producing a foam gasket is described.

The foam body can be produced by adding to a thermoplastic elastomer a thermally decomposed type foaming agent which thermally decomposes to generate a gas.

In the present Example, a master batch was prepared by kneading 4 parts by weight of the inorganic foaming agent with TPO: olefin-based thermoplastic elastomer (MFR: ASTM 1238, 190° C., 2.16 kgf, 10 g/10 minutes). PP film was inserted in the metal mold, and the master batch was injection-molded in the clamped metal mold consisting of the metal mold at the fixed side and the metal mold at the movable side, at a cylinder temperature of 200° C. (injection condition: injection speed 200 mm/s, metal mold temperature 40° C.). When the foamed molded product was removed from the metal mold, it was easily removed, and the molded foam gasket product (foam magnification 1.5 times) having the good molded state, in which the thermoplastic elastomer and PP film had been integrated in the fusion-bonded state was produced.

### Example 8

In the present Example, the process for attaching the gasket of the present invention to the cover for HDD is described.

The film-integrated gasket produced in the aforementioned embodiments, Example 6 or 7 was punched out into a gasket shape using Thompson knife. The olefin-based urethane reactive adhesive was applied onto the film side of the product, and this side to which the adhesive had been applied was adhered and fixed to the inside face of the cover for HDD. This gasket was reacted with moisture in air to solidify. Since this gasket is of nonsolvent type, it has a high clean degree. The sealing property thereof was extremely good.

### Example 9

In the present Example, the film-integrated gasket produced in the aforementioned embodiments, Example 6 or 7 was set in the gasket-fixing jig. Then PP film was peeled off and the surface of the cover for HDD was heated using the electric heater. Subsequently the gasket fixed to the fixing jig was placed in contact with the heated HDD cover, and fusion-bonded therewith with heat. The sealing property of the resulting HDD cover to which the gasket had been loaded was good.

### INDUSTRIAL APPLICABILITY

As described above in detail, according to the gasket, the method for producing the same and the method for attaching the gasket of the present invention, the following effects are obtained.
(1) The gasket can be produced by the injection molding method with good productivity, and the gasket which is easily removed from the mold can be provided.
(2) The gasket having the good workability when attached to the site to be sealed can be provided.
(3) The gasket made of the commonly available inexpensive materials can be obtained, which-enables reduction of the loss as possible and also enables the low cost.
(4) Even when the gasket is composed of the soft foam body, the gasket which is easily removed from the mold after the formation by the injection molding can be provided.
(5) The rationale method for attaching the gasket when the gasket is attached to the site to be sealed can be provided.

Therefore, the present invention is highly useful in industries associated with the gaskets.

1. A gasket comprising:
a resin film; and
an elastic body molded on the resin film by injection molding and composed of a thermoplastic elastomer.

2. The gasket according to claim 1 wherein said elastic body is fixed peelably onto one side of said resin film.

3. The gasket according to claim 2 wherein said elastic body is integrated and molded on one side of said resin film by insert molding.

4. The gasket according to claim 1 wherein:
said elastic body is fusion-bonded on one side of said resin film; and
said resin film is cut along a shape of said elastic body or an external shape of said elastic body.

5. The gasket according to claim 4 wherein said elastic body is integrated and molded on one side of said resin film by insert molding.

6. The gasket according to claim 1 wherein:
said resin film is composed of an olefin-based resin film; and
said elastic body is composed of an olefin-based or styrene-based elastomer.

7. A method for producing a gasket having a resin film and an elastic body composed of a thermoplastic elastomer, said method comprising peelably fixing said elastic body onto one side of said resin film to which a surface mold releasing treatment has not been given, by injection molding under a condition where said film is not fusion-bonded to said elastic body, to obtain a gasket.

8. The method for producing the gasket according to claim 7 wherein said condition where said film is not fusion-bonded is realized by setting a surface temperature of said resin film to a temperature equal to or less than a melting point of said resin film.

9. A method for producing a gasket having a resin film and an elastic body composed of a thermoplastic elastomer, said method comprising:
fusion-bonding said elastic body onto one side of said resin film to which a surface mold releasing treatment has not been given, by injection molding under a condition where said film is fusion-bonded to said elastic body; and
cutting said resin film to which said elastic body has been fusion-bonded, said cutting being performed along a shape of said elastic body or an external shape of said elastic body, to obtain the gasket.

10. A method for producing a gasket comprising:
continuously supplying a roll-shaped resin film or sheet-shaped resin films to a metal mold for injection molding; and
peelably fixing an elastic body onto one side of said resin film by continuously forming said elastic body on said resin film by injection molding under a condition where said resin film is not fusion-bonded to said elastic body composed of a thermoplastic elastomer, to obtain the gasket.

11. A method for producing a gasket comprising:
continuously supplying a roll-shaped resin film or sheet-shaped resin films to a metal mold for injection molding;
fusion-bonding an elastic body onto one side of said resin film by continuously forming said elastic body on said resin film by injection molding under a condition where said resin film is fusion-bonded to said elastic body composed of a thermoplastic elastomer; and
cutting said resin film on which said elastic body has been fusion-bonded, said cutting being performed along a shape of said elastic body or an external shape of said elastic body.

12. A method for attaching a gasket comprising:
peelably fixing an elastic body onto one side of a resin film, said elastic body having been molded by injection molding and composed of a thermoplastic elastomer;
fixing onto a site to be sealed an uncovered side of said elastic body which has been fixed to said resin film; and
peeling said resin film off from said elastic body fixed to said site to be sealed.

13. The method for attaching the gasket according to claim 12 wherein fixation of said elastic body to said site to be sealed is performed more strongly than fixation of said elastic body to said resin film.

14. The method for attaching the gasket according to claim 12 wherein fixation of said elastic body to said site to be sealed is effected using an adhesive.

15. The method for attaching the gasket according to claim 12 wherein fixation of said elastic body to said site to be sealed is effected by fusion-bonding with heat.

16. A method for attaching a gasket comprising:
peelably fixing an elastic body onto one side of a resin film, said elastic body having been molded by injection molding and composed of a thermoplastic elastomer;
retaining said elastic body by a fixing jig with keeping its shape;
subsequently peeling said resin film off from said elastic body;
fixing an uncovered peeled side of said elastic body onto a site to be sealed; and
removing said fixing jig from said elastic body fixed to said site to be sealed.

17. The method for attaching the gasket according to claim 16 wherein:
force of said fixing jig for retaining said elastic body is set more strongly than force for fixing said gasket to said resin film; and
fixation of said elastic body to the site to be sealed is set more strongly than force of said fixing jig for retaining said gasket.

18. The method for attaching the gasket according to claim 16 wherein fixation of said elastic body to said site to be sealed is effected using an adhesive.

19. The method for attaching the gasket according to claim 16 wherein fixation of said elastic body to said site to be sealed is effected by fusion-bonding with heat.

20. A method for attaching a gasket comprising:
providing a gasket comprising a resin film and an elastic body being fusion-bonded onto one side of said resin film, said elastic body being molded by injection molding and composed of a thermoplastic elastomer, and said resin film being cut along a shape of said elastic body or an external shape of said elastic body;
applying an adhesive onto at least all peripheral portion along an elastic body on a resin film surface of said gasket; and
sticking said gasket onto a site to be sealed.

21. A method for attaching a gasket comprising:
continuously supplying a roll-shaped resin film or sheet-shaped resin films to a metal mold for injection molding;
fusion-bonding an elastic body onto one side of said resin film by continuously forming said elastic body on said resin film by injection molding under a condition where said resin film is fusion-bonded to said elastic body composed of a thermoplastic elastomer;
cutting said resin film on which said elastic body has been fusion-bonded, said cutting being performed along a shape of said elastic body or an external shape of said elastic body;
applying an adhesive onto at least all peripheral portion along said elastic body on said resin film side; and
sticking the resin film onto a site to be sealed.

22. A method for attaching a gasket comprising:
providing a gasket comprising a resin film and an elastic body being fusion-bonded onto one side of said resin film, said elastic body being molded by injection molding and composed of a thermoplastic elastomer, and said resin film being cut along a shape of said elastic body or an external shape of said elastic body;
placing said resin film in contact with a site to be sealed; and
heating said resin film to stick said resin film onto said site to be sealed.

23. A method for attaching a gasket comprising:
continuously supplying a roll-shaped resin film or sheet-shaped resin films to a metal mold for injection molding;
fusion-bonding an elastic body onto one side of said resin film by continuously forming said elastic body on said resin film by injection molding under a condition where said resin film is fusion-bonded to said elastic body composed of a thermoplastic elastomer;
cutting said resin film on which said elastic body has been fusion-bonded, said cutting being performed along a shape of said elastic body or an external shape of said elastic body;
placing said resin film in contact with a site to be sealed; and
heating said resin film to stick said resin film onto said site to be sealed.
